(19) United States
(12) Patent Application Publication
(10) Pub. No.: US 2016/0121879 A1
(43) Pub. Date: May 5, 2016

(54) CONTROL SYSTEM, CONTROLLER AND CONTROL METHOD FOR HYBRID VEHICLE

(71) Applicant: TOYOTA JIDOSHA KABUSHIKI KAISHA, Toyota-shi, Aichi-ken (JP)

(72) Inventor: Hidekazu NAWATA, Gotemba-shi (JP)

(73) Assignee: TOYOTA JIDOSHA KABUSHIKI KAISHA, Toyota-shi, Aichi-ken (JP)

(21) Appl. No.: 14/895,256

(22) PCT Filed: May 28, 2014
(86) PCT No.: PCT/IB2014/000891

§ 371 Date: Dec. 2, 2015

(30) Foreign Application Priority Data
Jun. 3, 2013 (JP) 2013-117250

(51) Int. Cl. B60W 20/16; F02D 29/02; F01N 3/20

(52) U.S. Cl. CPC B60W 20/16; F01N 3/20; F02D 29/02; B60W 2710/0694; Y10S 903/905

(57) ABSTRACT

In a hybrid vehicle including an engine, motor generators, a purifier having a purification catalyst for reducing toxic substances contained in exhaust gas from the engine, output from the engine is controlled in accordance with the amount of the toxic substances contained in the exhaust gas from the engine, and target engine output is controlled on the basis of a warm up state of the engine and purification capability of the purifier, so that the amount of the toxic substances contained in the exhaust gas discharged from the purifier becomes less than a predetermined value.

### BACKGROUND OF THE INVENTION

1. Field of the Invention

The invention relates to a control system, a controller, and a control method for a hybrid vehicle having an exhaust gas purifier.

2. Description of Related Art

A control method of a hybrid vehicle that includes an engine and a motor is disclosed in Japanese Patent Application Publication No. 2012-158303 (JP 2012-158303 A). According to this method, when a warm up of the purification catalyst of an engine is requested, the execution time Tset1 of a first warm up control is set, where the engine is operated with setting a target rotation speed Ne* and a target torque Te* for outputting substantially zero power based on the state of charge (SOC) of a battery, and the execution time Tset2 of a second warm up control is set, where the engine is operated with setting a target rotation speed Ne* and a target torque Te* for outputting a target engine power Pe based on the execution time Tset1 of the first warm up control, and the first warm up control is executed throughout the first warm up time Tset1, then the second warm up control is executed throughout the second warm up time Tset2.

Another control method of a hybrid vehicle that includes an engine and a motor is disclosed in Japanese Patent Application Publication No. 2002-130030 (JP 2002-130030 A). According to this method, the engine is stably operated at a target output for warm up until a purification catalyst in a first step reaches a predetermined warm up degree T1, while leaving an output request to the vehicle and the changing of the output request mainly to the motor, and once the purification catalyst in the first step reaches a predetermined warm up degree, the engine is operated with increasing the engine power according to a request while limiting the increase speed to a predetermined increment or a predetermined increase rate, until a purification catalyst in a second step reaches a predetermined warm up degree T2, or until time Co, by which the purification catalyst in the second step is estimated to reach the warm up degree T2, elapses.

In a state of the engine that is warmed up, toxic substances, such as hydrocarbons (HC) and nitrogen oxides (NOx), in the exhaust gas from the engine become less. However in the related art, the warm up state of the engine is not considered, and even if the purification processing capability using the purification catalyst is sufficient, the fuel efficiency cannot be improved by increasing the target engine power Pe of the engine during warm up.

### SUMMARY OF THE INVENTION

A first aspect of the invention relates to a control system for a hybrid vehicle. The control system includes an engine, a motor, a secondary battery, a purifier and an electronic control unit (ECU). The engine is configured to output power for traveling. The motor is configured to output power for traveling as well. The secondary battery is configured to supply power to the motor. The purifier has a purification catalyst for reducing (purifying) toxic substances contained in exhaust gas from the engine. The ECU is configured to execute a warm up control that keeps a target engine output constant during a warm up operation for the purification catalyst. The ECU is configured to execute a control of the target engine output on the basis of a warm up degree of the engine and purification capability of the purifier, so that an amount of the toxic substances contained in the exhaust gas discharged from the purifier becomes less than a predetermined value.

In the control system, the ECU may be configured to determine the target engine output when the warm up operation for the purification catalyst is started, and execute the warm up control during the warm up operation for the purification catalyst.

In the control system, the ECU may be configured to execute the warm up control on the basis of the temperature of the cooling medium of the engine, so that the target engine output decreases as the temperature of the cooling medium lowers. The ECU may be also configured to execute the warm up control when the temperature of the cooling medium is a predetermined value or less.

In the control system, the ECU may be configured to execute the warm up control on the basis of the temperature of a cylinder of the engine, so that the target engine output decreases as the temperature of the cylinder lowers. The ECU may be also configured to execute the warm up control when the temperature of the cylinder is a predetermined value or less.

In the control system, the ECU may be configured to execute the warm up control on the basis of the temperature of the purification catalyst, so that the target engine output decreases as the temperature of the purification catalyst lowers. The ECU may be also configured to execute the warm up control when the temperature of the purification catalyst is a predetermined value or less.

A second aspect of the invention relates to a controller for a hybrid vehicle. The hybrid vehicle includes an engine configured to output power for traveling, a motor configured to output power for traveling, a secondary battery configured to supply power to the motor, and a purifier having a purification catalyst for purifying toxic substances contained in exhaust gas from the engine. The controller includes an ECU. The ECU is configured to execute a warm up control that keeps a target engine output constant during a warm up operation for the purification catalyst. The ECU is configured to execute a control of the target engine output on the basis of a warm up degree of the engine and purification capability of the purifier, so that the amount of the toxic substances contained in the exhaust gas discharged from the purifier becomes less than a predetermined value.

A third aspect of the invention relates to a control method for a hybrid vehicle. The hybrid vehicle includes an engine configured to output power for traveling, a motor configured to output power for traveling, a secondary battery configured to supply power to the motor, and a purifier having a purification catalyst for reducing toxic substances contained in exhaust gas from the engine. The control method includes: executing a warm up control that keeps a target engine output constant during a warm up operation for the purification catalyst; and executing a control of the target engine output on the basis of a warm up degree of the engine and the purification capability of the purifier, so that the amount of the toxic substances contained in the exhaust gas discharged from the purifier becomes less than a predetermined value.

According to each aspect of the invention, the target engine power Pe of the engine can be set depending on the processing capability of the purification catalyst and the warm up degree of the engine, and the fuel efficiency of the hybrid vehicle can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram depicting a configuration of a hybrid vehicle according to Embodiment 1;

FIG. 2 is a flow chart of a warm up operation control according to Embodiment 1;

FIG. 3 is an example of an engine power map according to Embodiment 1;

FIG. 4 is an example of an operation line for fuel efficiency of an engine;

FIG. 5 is a flow chart of a warm up operation control according to Embodiment 2; and

FIG. 6 is an example of an engine power map according to Embodiment 2.

### DETAILED DESCRIPTION OF EMBODIMENTS

<Basic Configuration>

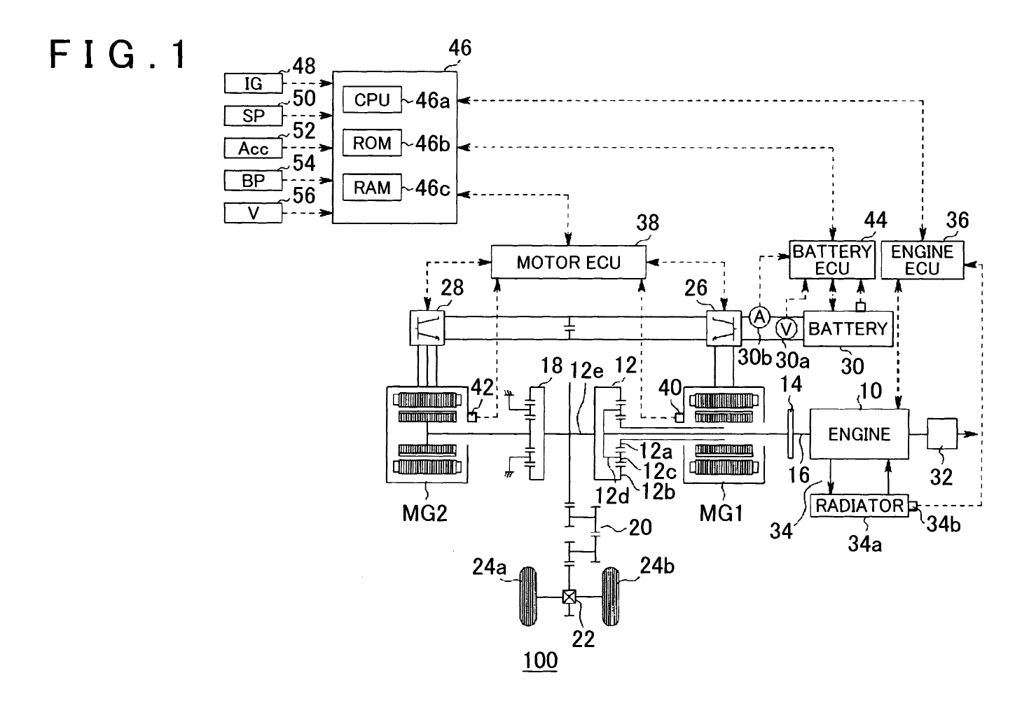

A hybrid vehicle 100 according to an embodiment of the invention includes an engine 10 and a power distribution integration mechanism 12, as shown in FIG. 1. The power distribution integration mechanism 12 is a triaxial power distribution integration unit, and is constructed as a planetary gear mechanism to which a sun gear 12a, a ring gear 12b, a pinion gear 12c and a carrier 12d are connected. In the power distribution integration mechanism 12, the carrier 12d is connected to a crankshaft 16, which is an output shaft of the engine 10, via a damper 14.

The hybrid vehicle 100 also includes motor generators (MG) 1 and MG2. A rotor of MG1 is connected to the sun gear 12a of the power distribution integration mechanism 12. A rotor of MG2 is connected to a ring gear shaft 12e of the ring gear 12b of the power distribution integration mechanism 12 via a speed reduction gear 18, and is connected to the driving wheels 24a and 24b via a gear mechanism 20 and a differential gear 22.

MG1 may be a generator and MG2 may be a motor. The motor is not limited to a synchronous generator motor, but can be any motor, such as an induction motor, if the power for traveling can be outputted.

The hybrid vehicle 100 also includes invertors 26 and 28 that constitute a drive circuit for driving MG1 and MG2, and a battery 30 that exchanges power with MG1 and MG2 via the invertors 26 and 28. The battery 30 can be, for example, a secondary battery, such as a lithium ion secondary battery, a nickel hydrogen secondary battery, a nickel cadmium secondary battery, or a lead storage battery. The battery 30 can be any storage unit that can be charged and discharged.

The engine is an internal combustion engine that can output power by HC based fuel, such as gasoline or diesel oil, for example. The engine 10 mixes gasoline and air, detonates and combusts the air-fuel mixture in a combustion chamber, and outputs a drive-force by converting the reciprocating motion of the piston that is pushed down by the energy in a rotary motion.

An internal combustion engine is not limited to an engine that outputs power by burning HC based fuel, such as gasoline or diesel oil, but can be any engine (e.g., a hydrogen engine) that can output power for traveling and that allows a purifier, having a purification catalyst for purifying exhaust air, to be installed in an exhaust system.

Exhaust from the engine 10 is discharged to the outside via a purifier 32 having a purification catalyst (three-way catalyst) for reducing toxic components of carbon monoxides (CO), HC and NOx.

In this embodiment, the catalyst temperature Tc of the purification catalyst is calculated based on an ignition timing of the engine 10 and an intake air quantity Qa to the engine 10, as described below, but a temperature sensor may be installed in a predetermined area (e.g. an approximately center area) of the purifier 32, and the catalyst temperature Tc may be measured by the temperature sensor.

The engine 10 is cooled by a cooling unit 34 that includes a radiator 34a. The cooling unit 34 circulates refrigerant, such as water, by a pump, so as to exchange heat between the engine 10 and the refrigerant, and cools the refrigerant by exchanging heat between the refrigerant that is warmed up by the radiator 34a and the outside air. A water temperature sensor 34b is installed in the cooling unit 34, whereby the cooling water temperature Tw, of the water that circulates around the water temperature sensor 34b, is measured.

In this embodiment, the cooling water temperature Tw is used to indirectly estimate a warm up state of the engine 10. Beside the cooling water temperature Tw, cylinder temperature, exhaust gas temperature or the like of the engine 10 can be used to detect the warm up state of the engine 10, but in this embodiment, an example of using the cooling water temperature Tw will be described.

The engine 10 is controlled by an engine ECU 36. Signals from various sensors, to detect the state of the engine 10, are inputted to the engine ECU 36. Examples of the signal data are a crank position to indicate a rotational position of the crankshaft 16, a cooling water temperature Tw from the water temperature sensor 34b, and an intake air quantity Qa from an air flow meter installed in an intake pipe. If necessary, the engine ECU 36 may acquire data on cylinder pressure from a pressure sensor installed in the combustion chamber, a cam position from a cam position sensor that detects a rotational position of a cam shaft for opening/closing an intake valve and an exhaust value to intake or exhaust air to/from the combustion chamber, a throttle position from a throttle valve position sensor that detects a position of a throttle valve, an intake air temperature Tin from a temperature sensor installed in the intake pipe, an air-fuel ratio from an air-fuel ratio sensor, an oxygen signal from an oxygen sensor or the like.

Various control signals for driving the engine 10 are also outputted from the engine ECU 36. As the control signals, a drive signal for a fuel injection valve, a drive signal for a throttle motor that adjusts a position of the throttle valve, a control signal for an ignition coil integrated with an igniter, a control signal for a variable valve timing mechanism that can change the opening/closing timing of the intake valve or the like are outputted via an output port.

The engine ECU 36 communicates with a hybrid ECU 46, so as to control operation of the engine 10 based on a control signal from the hybrid ECU 46, and to output data on the operation state of the engine 10 when necessary. The engine ECU 36 also computes a rotation speed of the crankshaft 16, that is, the rotation speed Ne of the engine 10, based on the crank position.

Both MG1 and MG2 are driven and controlled by a motor ECU (hereafter called “motor ECU”) 38. Signals required for driving and controlling MG1 and MG2 are inputted to the motor ECU 38. Examples of the input signals are signals from rotational position detection sensors 40 and 42 that detect a rotational position of the rotors of MG 1 and MG2 and phase current to MG1 and MG2 detected by a current sensor. A switching control signal to the invertors 26 and 28 is outputted from the motor ECU 38.

The motor ECU 38 communicates with the hybrid ECU 46, so as to drive and control MG1 and MG2 using the control signals from the hybrid ECU 46. When necessary, the motor ECU 38 outputs data on the operation state of MG1 and MG2 to the hybrid ECU 46. The motor ECU 38 also computes the rotation speeds Nm1 and Nm2 of MG1 and MG2 based on the signals from the rotational position detection sensors 40 and 42.

The battery 30 is managed by a battery ECU (hereafter called “battery ECU”) 44. Signals required for managing the battery 30 are inputted to the battery ECU 44. Examples of the input signal data are inter-terminal voltage Vb from a voltage sensor 30a installed between the terminals of the battery 30, and charge/discharge current Ib from a current sensor 30b installed in an output terminal on the cathode side of the battery 30. When necessary, the battery ECU 44 outputs data on the state of the battery 30 to the hybrid ECU 46.

In order to manage the battery 30, the battery ECU 44 computes a SOC, which is a ratio of a storage quantity that can be discharged from the battery 30 with respect to the total capacity, based on an integrated value of the charge/discharge current Ib detected by the current sensor 30b, or computes input/output limits Win and Wout, which indicate a maximum permissible power that allows a charge/discharge of the battery 30 based on the computed SOC and battery temperature Tb. The basic values of the input/output limits Win and Wout can be set based on the battery temperature Tb, and a correction coefficient for the output limit and a correction coefficient for the input limit can be set based on the SOC of the battery 30. The input/output limits Win and Wout are set by multiplying the basic values of the input/output limits Win and Wout that are set by the respective correction coefficients.

The hybrid vehicle 100 also includes the hybrid ECU 46 that controls the entire vehicle. The hybrid ECU 46 is a microprocessor that is centered around a central processing unit (CPU) 46a. Beside the CPU 46a, the hybrid ECU 46 also includes a ECUly memory (ROM) 46b that stores processing programs, a random access memory (RAM) 46c that temporarily stores data, input/output ports and communication ports.

To the hybrid ECU 46, an ignition signal IG from an ignition switch 48, a shift position SP from a shift position sensor 50 that detects an operation position of the shift lever, an accelerator depression amount Acc from an accelerator pedal position sensor 52 that detects the depression amount of an accelerator pedal, a brake pedal position BP from a brake pedal position sensor 54 that detects a depression amount of the brake pedal, vehicle speed V from a vehicle speed sensor 56 or the like, are inputted. As mentioned above, the hybrid ECU 46 is connected to the engine ECU 36, the motor ECU 38 and the battery ECU 44 via the communication ports, so as to exchange various control signals and data with the engine ECU 36, the motor ECU 38 and the battery ECU 44.

In this embodiment, the engine ECU 36, the motor ECU 38, the battery ECU 44 and the hybrid ECU 46 are independent control units, but all or a part of these units may be combined as an output control unit.

The hybrid vehicle 100 calculates a required torque to be outputted to a ring gear shaft 12e as a drive shaft, based on the accelerator depression amount Acc which corresponds to a depression amount of the accelerator pedal by a driver, and a vehicle speed V. Operations of the engine 10, MG1 and MG2 are controlled so that a required power corresponding to the required torque is outputted to the ring gear shaft 12e. To control the engine 10, MG1 and MG2 in normal operation, a torque conversion operation mode, a charge/discharge operation mode and a motor operation mode are available.

In the torque conversion operation mode, operation of the engine 10 is controlled so that power corresponding to the required power is outputted from the engine 10, and the driving of MG1 and MG2 are controlled so that all of the power (torque) outputted from the engine 10 is converted into the desired torque by the power distribution integration mechanism 12, MG1 and MG2, and are outputted to the ring gear shaft 12e. In the charge/discharge operation mode, the operation of the engine 10 is controlled so that the power corresponding to the total of the required power and the power required for charging/discharging of the battery 30 are outputted from the engine 10. The driving of MG1 and MG2 are controlled so that all or part of the power outputted from the engine 10, as a result of the charge/discharge of the battery 30, is converted into the desired torque by the power distribution integration mechanism 12, MG1 and MG2, whereby the required power is outputted to the ring gear shaft 12e. In the motor operation mode, operation of the engine 10 is stopped and operation is controlled so that the power corresponding to the required power is outputted from MG2 to the ring gear shaft 12e.

<Warm Up Operation Control Method in Embodiment 1>

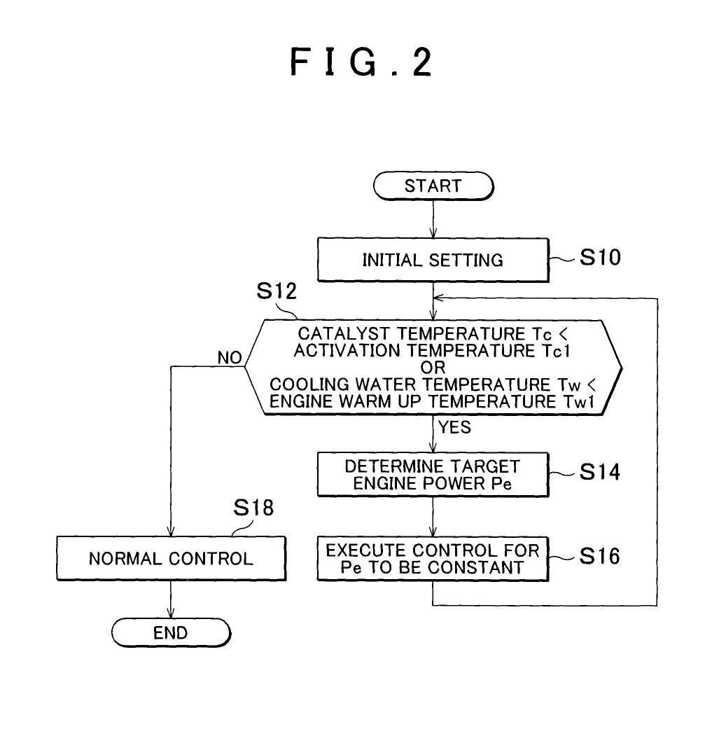

Operation of warming up the purification catalyst of the purifier 32 of the engine 10 will now be described. FIG. 2 is a flow chart of a drive control routine according to Embodiment 1. The drive control routine is started when an ignition signal is inputted to the hybrid ECU 46 by the ignition switch 48. This drive control routine is repeatedly executed at every predetermined time (e.g. at every several msec.).

When the drive control routine is executed, initial setting processing is executed. The CPU 46a of the hybrid ECU 46 acquires data required for control first, such as the accelerator depression amount Acc from the accelerator pedal position sensor 52, the vehicle speed V from the vehicle speed sensor 56, the rotation speeds Nm1 and Nm2 of MG1 and MG2, the input/output limits Win and Wout of the battery 30, and the catalyst warm up request flag Fc for indicating whether warm up for the purification catalyst is requested or not (Step S10).

Here the rotation speeds Nm1 and Nm2 of MG1 and MG2 are computed by the motor ECU 38 based on the rotational positions of the rotors of MG1 and MG2 detected by the rotational position detection sensors 40 and 42. The rotation speeds Nm1 and Nm2 are inputted from the motor ECU 38 to the hybrid ECU 46. The input/output limits Win and Wout of the battery 30 are set based on the battery temperature Tb of the battery 30 and the SOC of the battery 30. The input/output limits Win and Wout are inputted from the battery ECU 44 to the hybrid ECU 46 via a communication (a communication port).

Then the catalyst temperature Tc of the purifier 32 and the cooling water temperature Tw of the water temperature sensor 34b are inputted from the engine ECU 36 to the hybrid ECU 46. Here for the catalyst temperature Tc, the relationship of the ignition timing of the engine 10, an integrated value of the intake air quantity Qa to the engine 10, and the catalyst temperature Tc is checked by experiments and a map (data base) is created in advance based on this relationship, thereby the catalyst temperature Tc is determined according to the combination of the actual ignition timing of the engine 10 and the integrated value of the intake air quantity Qa set to the engine 10 at a given time. The catalyst temperature Tc may be directly measured by a temperature sensor that is installed in the purifier 32.

The hybrid ECU 46 determines whether the catalyst temperature Tc of the purifier 32 is less than an activation temperature Tc1 (which is set in a 400° C. to 450° C. temperature range, for example), or whether the cooling water temperature Tw of the water temperature sensor 34b is less than an engine warm up temperature Tw1 (step S12).

If the catalyst temperature Tc of the purifier 32 is less than the activation temperature Tc1, or if the cooling water temperature Tw of the water temperature sensor 34b is less than the engine warm up temperature Tw1, the hybrid ECU 46 sets the catalyst warm up request flag Fc value to 1, and advances the processing to step S14, otherwise the hybrid ECU 46 sets the catalyst warm up request flag Fc value to 0, and advances the processing to step S18.

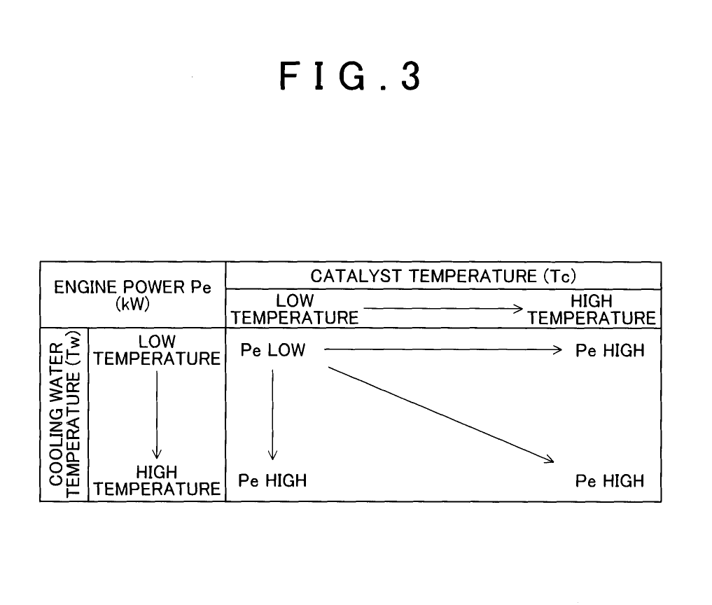

If the value of the catalyst warm up request flag Fc is 1, then the hybrid ECU 46 determines a target engine power Pe, which is an output of the engine 10 in accordance with the catalyst temperature Tc and the cooling water temperature Tw (step S14). In this embodiment, as shown in FIG. 3, a target engine power Pe, by which the concentration of toxic substances (e.g. HC, NOx) in the exhaust gas that passed through the purifier 32 becomes less than a predetermined standard value, with respect to the catalyst temperature Tc and the cooling water temperature Tw, is determined in advance by experiments, and the result is mapped and stored in the ROM 46b. Referring to this map, the hybrid ECU 46 selects a target engine power Pe corresponding to the combination of the actual catalyst temperature Tc and the cooling water temperature Tw.

When the hybrid vehicle 100 is started for the first time, the catalyst temperature Tc cannot be calculated by the above mentioned calculation method. Therefore the target engine power Pe is determined from the cooling water temperature Tw alone, assuming that the catalyst temperature Tc is the lowest value on the map.

In this case, as shown in FIG. 3, the target engine power Pe in the warm up operation control is set so as to be a greater value as the catalyst temperature Tc is higher, and be a greater value as the cooling water temperature Tw is higher. As the catalyst temperature Tc increases, the capability to remove toxic substances in the exhaust gas in the purifier 32 improves and the toxic substances in the exhaust gas can be removed more sufficiently. Hence the amount of the toxic substances in the gas discharged from the purifier 32 can also be maintained to be less than a standard value even if the total amount of the exhaust gas is increased by increasing the target engine power Pe. Further, as the cooling water temperature Tw increases, the amount of toxic substances contained in the exhaust gas from the engine 10 decreases, therefore the toxic substances in the exhaust gas can be removed sufficiently by the purifier 32. Hence the amount of the toxic substances in the gas discharged from the purifier 32 can also be maintained to be less than a standard value even if the total amount of the exhaust gas is increased by increasing the target engine power Pe.

The target engine power Pe, by which the concentration of toxic substances (e.g. HC, NOx) in the exhaust gas that passed through the purifier 32 becomes less than a predetermined value (e.g. environmental standard value for toxic substances contained in the exhaust gas discharged from the hybrid vehicle 100), may be determined in advance as the functions of the catalyst temperature Tc and the cooling water temperature Tw, so that the target engine power Pe is calculated by substituting the actual catalyst temperature Tc and the cooling temperature Tw in the functions.

The hybrid ECU 46 controls the hybrid vehicle 100 using the determined target engine power Pe (step S16).

The hybrid ECU 46 sets a required torque Tr* to be outputted to the ring gear shaft 12e, which is a drive shaft connected to the driving wheels 24a and 24b, as a torque required for the vehicle based on the inputted accelerator depression amount Acc and the vehicle speed V. The hybrid electric control unit also sets a traveling power Pdrv* which is required for traveling. For the required torque Tr*, a relationship of the acceleration depression amount Acc, the vehicle speed V and the required torque Tr* is predetermined and stored in the ROM 46b as a required torque setting map in advance, and if the accelerator depression amount Acc and the vehicle speed V are provided, the corresponding required torque Tr* is selected from the stored map and is set. The traveling power Pdrv* is derived by multiplying the required torque Tr* that is set by the rotation speed Nr of the ring gear shaft 12e, and adding a loss Loss to the multiplied value.

The rotation speed Nr of the ring gear shaft 12e can be determined by multiplying the vehicle speed V by a conversion coefficient, or by dividing the rotation speed Nin2 of MG2 by the gear ratio Gr of the speed reduction gear 18.

The hybrid ECU 46 compares the traveling power Pdrv* with the total of the maximum battery output power (k·Wout) and the target engine power Pe, that is, the total power (k·Wout+Pe). By this processing, it is determined whether traveling is possible with the traveling power Pdrv* while outputting the target engine power Pe from the engine 10. If the traveling power Pdrv* is the total power (k·Wout+Pe) or less, the hybrid ECU 46 sets the target engine power Pe as the required power Pe* to be outputted from the engine 10, and sets a rotation speed and a torque, which are acquired using an operation line for efficiently operating the engine 10 (hereafter called “operation line for fueling efficiency”) and the required power Pe* as the target rotation speed Ne and the target torque Te of the engine 10, as the rotation speed Ne* and the torque Te* of the engine 10.

Further, the hybrid ECU 46 sets torque instructions Tm1* and Tm2* of MG1 and MG2 using the target rotation speed Ne* and the target torque Te* that are set. The hybrid ECU 46 calculates the target rotation speed Nm1* of MG1 by the following Expression (1), using the target rotation speed Ne* of the engine 10, the rotation speed Nm2 of MG2, the gear ratio p of the power distribution integration mechanism 12, and the gear ratio Gr of the speed reduction gear 18. Furthermore, the hybrid ECU 46 calculates the torque instruction Tm1* of MG1 by Expression (2) based on the calculated target rotation speed Nm1*, the rotation speed Nm1 of MG1, the target torque Te* of the engine 10, and the gear ratio ρ of the power distribution integration mechanism 12.

Nm1*=Ne*·(1+ρ)/ρ−Nm2/(Gr·ρ) (1)

Tm1tmp=−ρ·Te*/(1+ρ)+k1·(Nm1*−Nm1)+k2·∫(Nm1*−Nm1)dt (2)

Expression (1) is a mechanical relational expression of the rotational elements of the power distribution integration mechanism 12. Expression (1) can be derived from a collinear chart that indicates the mechanism relationship between the rotation speed and the torque of the rotational elements of the power distribution integration mechanism 12. Expression (2) is a relational expression in the feedback control for rotating MG1 at the target rotation speed Nm1*. In Expression (2), “k1” in the second term on the right side is a gain of a proportional term, and “k2” in the third term on the right side is a gain of an integral term.

A temporary torque Tm2tmp, which is a temporary value of the torque to be outputted from MG2, is calculated based on Expression (3). The temporary torque Tm2tmp is a value generated by dividing the torque instruction value Tm1* by the gear ratio ρ of the power distribution integration mechanism 12, adding the required torque Tr* thereto, and dividing the result by the gear ratio Gr of the speed reduction gear 18.

The torque limits Tm2min and Tm2max are calculated based on Expression (4) and Expression (5). The torque limit Tm2min is calculated by determining the difference value, between the consumed power (generated power) value of MG1, which is acquired by multiplying the torque instruction Tm1*, by the current rotation speed Nm1 of MG1, and the input/output limit Win of the battery 30, and dividing this difference value by the rotation speed Nm2 of MG2. The torque limit Tm2min is a lower limit value of the torque which may be outputted from MG2. The torque limit Tm2max is calculated by determining the difference value, between the consumed power (generated power) value of MG1, which acquired by multiplying the torque instruction Tm1* by the current rotation speed Nm1 of MG1, and the input/output limit Wout of the battery 30, and dividing this difference value by the rotation speed Nm2 of MG2. The torque limit Tm2max is an upper limit value of the torque which may be outputted from MG2. The temporary torque Tm2tmp is limited by the torque limits Tm2min and Tm2max by Expression (6), and the torque instruction Tm2* of MG2 is set. Here Expression (3) is derived from a collinear chart, just like Expression (1).

Tm2tmp=(Tr*+Tm1*/ρ)/Gr (3)

Tm2min=(Win−Tm1*·Nm1)/Nm2 (4)

Tm2max=(Wout−Tm1*·Nm1)/Nm2 (5)

Tm2*=max(min(Tm2tmp,Tm2max),Tm2min) (6)

By setting the torque instruction Tm2* of MG2, the required torque Tr* to be outputted to the ring gear shaft 12e, which is a drive shaft, can be set as a torque limited within the range of the input/output limits Win and Wout of the battery 30.

In this way, the target rotation speed Ne* and the target torque Te* of the engine 10 and the torque instructions Tm1* and Tm2* of MG1 and MG2 are set. The hybrid ECU 46 transmits the target rotation speed Ne* as the target torque Te* of the engine 10 that are set to the engine ECU 36, and transmits the torque instructions Tm1* and Tm2* of MG1 and MG2 to the motor ECU 38.

When the target rotation speed Ne* and the target torque Te* are received, the engine ECU 36 outputs a throttle valve position drive signal (intake air quantity control signal), a fuel injection valve drive signal (fuel injection control signal), an ignition coil control signal (ignition control signal) or the like to the engine 10, so that the engine 10 is driven at an operation point determined by the target rotation speed Ne* and the target torque Te*. Thereby the intake air quantity control, fuel injection control, ignition control or the like of the engine 10 are executed so that operation in accordance with the target rotation speed Ne* and the target torque Te* are performed. In this case, it is preferable that in order to implement warm up of the purification catalyst the ignition timing of the engine 10 is a timing later than the ignition timing to efficiently operation the engine 10 (hereafter called “ignition timing for fuel efficiency”), in other words, the ignition timing is an ignition timing that is appropriate for catalyst warm up (hereafter called “ignition timing for catalyst warm up”). When the torque instructions Tm1* and Tm2* are received, the motor ECU 38 controls the switching of the switching elements of the invertors 26 and 28, so that MG1 is driven by the torque instruction Tm1*, and MG2 is driven by the torque instruction Tm2*.

If the value of the catalyst warm up request flag Fc is 0 in step S12, that is, if the catalyst temperature Tc is the activation temperature Tc1 or more and the cooling water temperature Tw is the engine warm up temperature Tw1, the hybrid ECU 46 shifts the operation control to the normal operation control. In the normal operation control, control is performed in one of the torque conversion operation mode, the charge/discharge operation mode and the motor operation mode, as described above.

If the catalyst temperature Tc becomes the activation temperature Tc1 or more, the hybrid ECU 46 may shift the operation control to the normal operation control, even if the cooling water temperature Tw has not yet reached the engine warm up temperature Tw1.

In this embodiment as described above, if the purification catalyst has not been sufficiently warmed up, or if the engine has not been sufficiently warmed up, the target engine power Pe from the engine 10 is determined in accordance with the cooling water temperature Tw of the engine 10. As the cooling water temperature Tw increases, the engine 10 is warmed up and the amount of the toxic substances contained in the exhaust gas from the engine 10 decreases, therefore the amount of the toxic substances in the gas discharged from the purifier 32 can be maintained to be less than the standard value, even if the target engine power Pe is increased. Further, the activation degree of the catalyst increases as the catalyst temperature Tc increases, therefore the amount of the toxic substances in the gas discharged from the purifier 32 can be maintained to be less than the standard value, even if the target engine power Pe is increased.

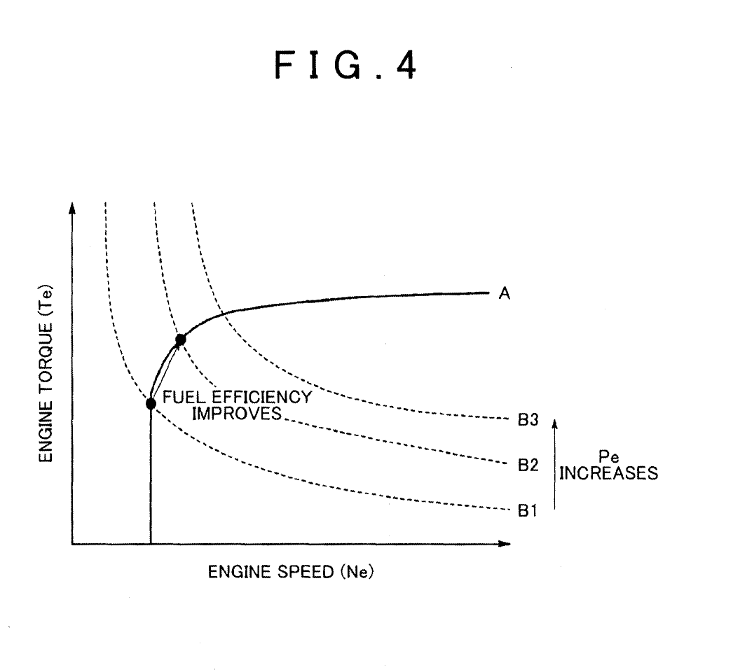

In this case, as shown in FIG. 4, the target rotation speed Ne* and the target torque Te* are determined by an intersection between the fuel efficiency operation line A and an equal-power curve B (B1, B2, . . . ) where the target engine power Pe is constant. As FIG. 4 shows, as the target engine power Pe increases, the target rotation speed Ne* and the target torque Te* increase, and the fuel efficiency of the engine 10 also improves. In this embodiment, the target engine power Pe is increased as the cooling water temperature Tw increases, even during warm up operation control, hence the fuel efficiency of the engine 10 can be improved in a range where the amount of the toxic substances in the gas discharged from the purifier 32 can be maintained to be less than the standard value.

<Warm Up Operation Control Method in Embodiment 2>

In the warm up operation control in Embodiment 1, the target engine power Pe of the engine 10 is set in accordance with the change of the catalyst temperature Tc and the cooling water temperature Tw during the warm up operation, but in Embodiment 2, the target engine power Pe is constant during the warm up operation.

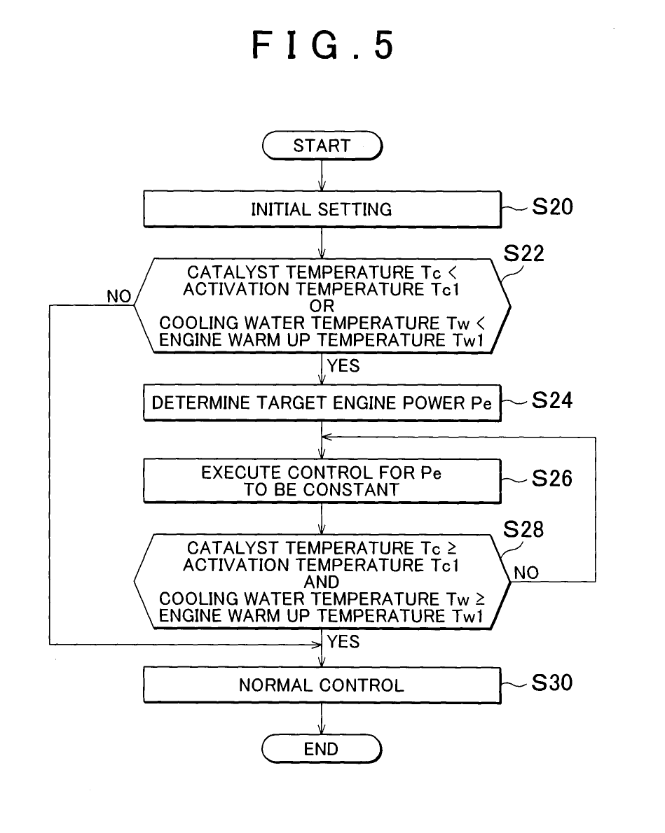

FIG. 5 is a flow chart of a drive control routine according to Embodiment 2. The drive control routine is started when an ignition signal is inputted to the hybrid ECU 46 by the ignition switch 48. This drive control routine is repeatedly executed at every predetermined time (e.g. at every several msecs.).

When the drive control routine is executed, initial setting processing is executed (step S20). This processing is executed in the same manner as step S10 in Embodiment 1.

Then the hybrid ECU 46 determines whether the catalyst temperature Tc of the purifier 32 is less than the activation temperature Tc1, or whether the cooling water temperature Tw of the water temperature sensor 34b is less than the engine warm up temperature Tw1 (step S22). If the catalyst temperature Tc of the purifier 32 is less than the activation temperature Tc1, or if the cooling water temperature Tw of the water temperature sensor 34b is less than the engine warm up temperature Tw1, the hybrid ECU 46 sets the catalyst warm up request flag Fc value to 1, and advances the processing to step S24, otherwise the hybrid ECU 46 sets the catalyst warm up request flag Fc value to 0, and advances the processing to step S30.

If the value of the catalyst warm up request flag Fc is 1, then the hybrid ECU 46 determines a target engine power Pe, which is an output of the engine 10 according to the cooling water temperature Tw (step S24). In this embodiment, the target engine power Pe is maintained constant during the warm up operation control. When the hybrid vehicle 100 is started the first time, the catalyst temperature Tc cannot be calculated, therefore the target engine power Pe is determined from the cooling water temperature TW alone.

In this embodiment, a target engine power Pe, by which the concentration of toxic substances (e.g. HC, NOx) in the exhaust gas that passed through the purifier 32 becomes less than a predetermined standard value, with respect to the cooling water temperature Tw, is determined in advance by experiments, and the result is mapped. Referring to this map, the hybrid ECU 46 selects a target engine power Pe corresponding to the actual cooling water temperature Tw.

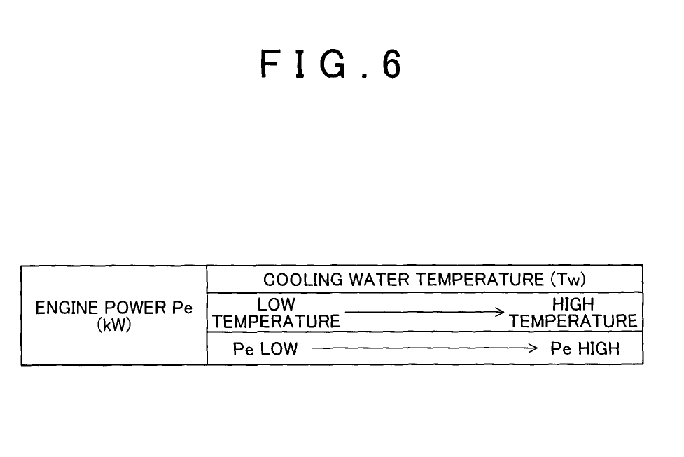

FIG. 6 is an example of a map indicating the relationship of the cooling water temperature Tw and the target engine power Pe under the warm up operation control. For example, when the catalyst temperature Tc is a constant value (e.g. lowest temperature that is expected as the catalyst temperature Tc in the environment where the hybrid vehicle 100 is used, or normal temperature), a target engine power Pe, by which the concentration of toxic substances (e.g. HC, NOx) in the exhaust gas that passed through the purifier 32 becomes less than a predetermined standard value, with respect to the cooling water temperature Tw, is determined in advance by experiments, and the result is mapped and stored in the ROM 46b.

The target engine power Pe is set so as to be a greater value as the cooling water temperature Tw increases. In other words, as the cooling water temperature Tw increases, the amount of the toxic substances contained in the exhaust gas from the engine 10 decreases, and the toxic substances in the exhaust gas can be sufficiently removed by the purifier 32, hence the amount of the toxic substances in the gas discharged from the purifier 32 can be maintained to be less than a standard value, even if the target engine power Pe is increased and the total amount of the exhaust gas is increased.

The target engine power Pe, by which the concentration of the toxic substances (e.g. HC, NOx) in the exhaust gas that passed through the purifier 32 becomes less than a predetermined value (e.g. environmental standard values for toxic substances contained in the exhaust gas discharged from the hybrid vehicle 100), may be determined in advance as a function of the cooling water temperature Tw, so that the target engine power Pe is calculated by substituting the actual cooling water temperature Tw in the function.

Then the hybrid ECU 46 controls the hybrid vehicle 100 using the determined target engine power Pe (step S26). This processing is executed in the same manner as step S16 in Embodiment 1.

Then the hybrid ECU 46 determines whether the catalyst temperature Tc of the purifier 32 is the activation temperature Tc1 or more and the cooling water temperature Tw of the water temperature sensor 34b is the engine warm up temperature Tw1 or more (step S28). If the catalyst temperature Tc of the purifier 32 is the activation temperature Tc1 or more and the cooling water temperature Tw of the water temperature sensor 34b is the engine warm up temperature Tw1 or more, the hybrid ECU 46 sets the catalyst warm up flag Fc value to 0, and advances the processing to step S30, otherwise the hybrid ECU 46 maintains the catalyst warm up request flag Fc value at 1, and returns the processing to step S26.

If the value of the catalyst warm up request flag Fc value is set to 0 in step S22 or step S28, the hybrid ECU 46 shifts the operation control to the normal control operation. This processing is executed in the same manner as step S18 in Embodiment 1.

In this embodiment, as described above, if the purification catalyst has not been sufficiently warmed up or if the engine has not been sufficiently warmed up, the target engine power Pe from the engine 10 is determined in accordance with the cooling water temperature Tw of the engine 10, and the engine 10 is operated with the target engine power Pe for warm up. In this embodiment, the target engine power Pe is maintained constant during the warm up operation, but the target engine power Pe is set in accordance with the cooling water temperature Tw at the start of the warm up operation, hence the fuel efficiency of the engine 10 can be improved in a range where the amount of the toxic substances in the gas discharged from the purifier 32 can be maintained to be less than the standard value.

In Embodiment 1 and Embodiment 2, the warm up state of the engine 10 is determined by the cooling water temperature Tw of the engine 10, but the state can also be determined by the amount of the toxic substances contained in the exhaust gas from the engine 10.

In other words, in this embodiment, the target engine power Pe from the engine 10 is determined in accordance with the cooling water temperature Tw of the engine 10, but if the amount of the toxic substances contained in the exhaust gas from the engine 10 can be directly measured, the target engine power Pe during the warm up operation may be determined in accordance with the amount of the toxic substances, instead of the cooling water temperature Tw. Here during the warm up operation, the target engine power Pe may be changed when necessary as in the case of Embodiment 1, or the target engine power Pe may be maintained constant as in the case of Embodiment 2. It is preferable to control so that the target engine power Pe during the warm up operation is increased as the amount of the toxic substances decreases.

The warm up state of the engine 10 can also be determined by the temperature of a cylinder of the engine 10.

In other words, if the temperature of the cylinder of the engine 10 can be measured, the target engine power Pe during the warm up operation may be determined in accordance with the temperature of the cylinder, instead of the cooling water temperature Tw. During the warm up operation, the target engine power Pe may be changed when necessary as in the case of Embodiment 1, or the target engine power Pe may be maintained constant as in the case of Embodiment 2. Here it is preferable that the target engine power Pe during the warm up operation is increased as the temperature of the cylinder is higher.

The applicable range of the invention is not limited to a hybrid vehicle, but can be any hybrid system combining an internal combustion engine and a motor, including a purification catalyst for removing or reducing the toxic substances contained in the exhaust gas from the internal combustion engine.

Hybrid vehicles in the applicable range are not limited to the configuration described in the embodiments, and this invention is applicable to hybrid vehicles having various configurations.

1. A control system for a hybrid vehicle, the control system comprising:
an engine configured to output power for traveling;
a motor configured to output power for traveling;
a secondary battery configured to supply power to the motor;
a purifier having a purification catalyst for reducing toxic substances contained in exhaust gas from the engine; and
an electronic control unit configured to:
determine a target engine output based on a warm up degree of the engine and a purification capability of the purifier when a warm up operation for the purification catalyst starts;
(i) maintain the target engine output constant during a warm up operation for the purification catalyst,
(ii) control the target engine output based on the warm up degree of the engine and the purification capability of the purifier, so that an amount of the toxic substances contained in the exhaust gas discharged from the purifier becomes less than a predetermined value, and
(iii) determine the target engine output based on a required power when the warm up degree of the engine and the purification capability of the purifier have reached or exceeded a respective predetermined value.

2. (canceled)

3. The control system according to claim 1, wherein
the electronic control unit is configured to determine the target engine output based on a temperature of a cooling medium of the engine, so that the target engine output is low when the temperature of the cooling medium is low.

4. The control system according to claim 3, wherein
the electronic control unit is configured to determine the target engine output when the temperature of the cooling medium is a predetermined value or less.

5. The control system according to claim 1, wherein
the electronic control unit is configured to determine the target engine output based on a temperature of a cylinder of the engine, so that the target engine output is low when the temperature of the cylinder is low.

6. The control system according to claim 5, wherein
the electronic control unit is configured to determine the target engine output when the temperature of the cylinder is a predetermined value or less.

7. The control system according to claim 1, wherein
the electronic control unit is configured to determine the target engine output based on a temperature of the purification catalyst, so that the target engine output is low when the temperature of the purification catalyst is low.

8. The control system according to claim 7, wherein
the electronic control unit is configured to determine the target engine output when the temperature of the purification catalyst is a predetermined value or less.

9. A controller for a hybrid vehicle including an engine configured to output power for traveling, a motor configured to output power for traveling, a secondary battery configured to supply power to the motor, and a purifier having a purification catalyst for purifying toxic substances contained in exhaust gas from the engine,
the controller comprising:
an electronic control unit configured to:
determine a target engine output based on a warm up degree of the engine and a purification capability of the purifier when a warm up operation for the purification catalyst starts;
(i) maintain the target engine output constant during a warm up operation for the purification catalyst,
(ii) control the target engine output based on a warm up degree of the engine and purification capability of the purifier, so that an amount of the toxic substances contained in the exhaust gas discharged from the purifier becomes less than a predetermined value, and
(iii) determine the target engine output based on a required power when the warm up degree of the engine and the purification capability of the purifier have reached or exceeded a respective predetermined value.

10. A control method for a hybrid vehicle including an engine configured to output power for traveling, a motor configured to output power for traveling, a secondary battery configured to supply power to the motor, and a purifier having a purification catalyst for reducing toxic substances contained in exhaust gas from the engine,
the control method comprising:
determining a target engine output based on a warm up degree of the engine and a purification capability of the purifier at a time when a warm up operation for the purification catalyst starts;
maintaining the target engine output constant during a warm up operation for the purification catalyst;
controlling the target engine output based on a warm up degree of the engine and purification capability of the purifier, so that an amount of the toxic substances contained in the exhaust gas discharged from the purifier becomes less than a predetermined value; and
determining the target engine output based on a required power when the warm up degree of the engine and the purification capability of the purifier have reached or exceeded a respective predetermined value.
